(19) United States
(12) Patent Application Publication
(10) Pub. No.: US 2008/0178997 A1
(43) Pub. Date: Jul. 31, 2008

(54) LIQUID CRYSTAL PANEL FOR LIQUID CRYSTAL DISPLAY DEVICE AND THE MANUFACTURE METHOD OF THE SAME

(75) Inventors: Hiroyuki Kamiya, Yokohama (JP); Kenta Kamoshida, Kawasaki (JP)

Correspondence Address: CALFEE HALTER & GRISWOLD, LLP, 800 SUPERIOR AVENUE, SUITE 1400, CLEVELAND, OH, 44114, US

(73) Assignee: INFOVISION OPTOELECTRONICS HOLDINGS LIMITED, Road Town (VG)

(21) Appl. No.: 11/945,403

(22) Filed: Nov. 27, 2007

(30) Foreign Application Priority Data
Nov. 28, 2006 (JP) 2006-320515

(51) Int. Cl. B29C 65/00

(52) U.S. Cl. 156/290; 349/106

(57) ABSTRACT

The invention discloses a liquid crystal panel used for liquid crystal display device and a method for manufacturing the same. The object of the invention is to provide a liquid crystal panel having the following structure in order to utilize effectively the peripheral portion of the liquid crystal panel: in a liquid crystal panel which is formed by sandwiching the liquid crystal between a TFT substrate configured with the pixels in a matrix shape and a CF substrate configured with the color filter and sealing the peripheral area with a seal material, the seal material is completely overlappingly disposed on the BM of the CF substrate, and in order to electrically connect said TFT substrate and said CF substrate, a conductive material is adjoined at the outer side of said seal material and is configured to overlap the BM completely, and a structure in which said BM only projects outwardly at the portion, where said conductive material is disposed, is formed. Wherein said conductive material comprises electric transfer isolation component with the electric transfer film disposed on the surface of the isolation component. Therefore, the reduction of the yield rate, which is caused by black matrix being cut off when the cut off line shifts slightly during cutting the substrate, can be decreased while the peripheral portion of the liquid crystal panel substrate is utilized effectively.

### FIELD OF THE INVENTION

The invention relates to a liquid crystal panel used for liquid crystal display device and a manufacture method of the same.

### DESCRIPTION OF THE RELATED ART

In recent years, TFT-LCD (Thin Film Transistor-Liquid Crystal Display) panel has been used widely as the panel of the display of the desktop personal computer and the display device of the notebook personal computer. For the future TFT-LCD, besides it must satisfy the performances required for operating as a display device, the following two points are very important at an aspect of reducing the cost, that is, promoting production efficiency by using larger mother glass substrate and improving effectiveness of batch production by adopting means such as the generalization of components.

Therefore, at an aspect which is indispensable for promoting the production efficiency, that is, at an aspect referred to as “multiple-panel-cutting for cutting a plurality of LCD panels from one mother glass substrate”, how many LCD panels can be configured is an important parameter relating directly to the throughput. If more panels can be configured, then the result of the batch production will be improved, and the cost of the panel will be decreased.

Therefore, how to decrease the space outside the pixel region having the determinate specifications, that is, the peripheral region, is an important technical subject.

FIG. 1 is a part plan view illustrating the configuration relationship among a black matrix (Hereinafter referred to as “BM”) of a Color Filter (CF) substrate at the peripheral area of TFT-LCD panel, a seal material, and a conductive material in the prior art.

As shown in FIG. 1, the seal material and the conductive material exist at the peripheral area of the prior TFT-LCD panel, wherein the seal material is used to adhere the CF substrate to the TFT substrate and the conductive material electrically connects the electrodes disposed on the CF substrate to the electrodes disposed on the TFT substrate, therefore the voltage needed by the CF substrate side can be applied from the TFT substrate side.

In FIG. 1, 101 is a seal material, 102 is a BM, 103 is a cut-off line for cutting a mother glass, 104 is a conductive material and 105□107 are the pigmentation portions of the CF substrate.

FIG. 2 is a cross sectional views taken along the cut off line A-A in FIG. 1.

In FIG. 2, 201 is a CF substrate, 202 is a TFT substrate, and 203 is wiring.

As shown in FIG. 1 and FIG. 2, the seal material 101 and the conductive material 104 are configured at the outer side of BM 102 in the prior TFT-LCD panel.

In addition, a material formed by filling the conductive balls, which are formed by coating the conductive film on the surfaces of the tiny particles, into the adhesive material, such as UV cured seal material, is used generally as a conductive material, and said conductive material is coated on the substrate. The adhesive material does not possess any electric conductivity, so when the UV cured seal material is cured, the conductive balls are pressed by a height about 5%˜120% of the diameter, the stable electric conductivity of a conductive material can be obtained.

As shown in FIG. 3 and FIG. 4, in order to decrease the peripheral region, if the UV cured seal material 101 and the conductive material 104 are not disposed at the outer side of the BM 102 of the CF substrate, but disposed under side of the BM 102 in superposition, and the cut-off line 103 is disposed near the BM 102, then the peripheral region can be reduced.

FIG. 3 is a part plan view in a condition that the seal material 101 and the conductive material 104 are not disposed at the outer side of the BM 102 of the CF substrate, but disposed under side of the BM 102 in superposition.

FIG. 4 is a cross sectional view taken along the cut-off line B-B in FIG. 3.

In FIG. 4, 401 is the portion containing the regions where the conductive material 104 and the BM 102 overlap and the regions where the conductive material 104 and the BM 102 do not overlap in the conductive material 104.

As shown in FIG. 3 and FIG. 4, the peripheral region can be reduced surely when the BM 102 partly overlaps the conductive material 104. However, the region where the conductive material 104 and the BM 102 overlap and the region where the conductive material 104 and the BM 102 do not overlap are formed in the conductive material 104, and the thickness of the conductive material 104 in the region where the conductive material 104 and the BM 102 overlap and in the region where the conductive material 104 and the BM 102 do not overlap are different. As a result, the portion comprised in the conductive material, which contains the conductive balls, has not been pressed at all, so that the electric connection cannot be obtained between the conductive material and the CF substrate and/or the TFT substrate, or they cannot be fully electrically connected. Therefore, the total electrical conductivity of the conductive material 104 is decreased. This will be described based on the figures as follows.

FIG. 5 is an enlarged cross sectional view of the portion 401 in FIG. 4.

In FIG. 5, 501 is conductive balls, D1 is a region where the conductive material 104 and the BM 102 overlap, D2 is a region where the conductive material 104 and the BM 102 do not overlap, H1 is the thickness of the conductive material 104 in the region D1, and H2 is the thickness of the conductive material 104 in the region D2.

H1 is merely thinner than H2 by the thickness of the BM 102, because the conductive material 104 and the BM 102 overlap. The result is that even though the conductive balls 501 existing in the region D1 are pressed, the conductive balls existing in the region D2 are almost not pressed. Because the adhesive material itself forming the conductive material 104 does not possess electric conductivity, when the conductive balls 501 are pressed between the substrates used as the objects to be connected, the conductive balls 501 electrically connect the two substrates, thereby they become the components for electrically connecting two substrates, so in the region D2 where the conductive balls have not been pressed substantially, the electric conductivity between the CF substrate 201 and the TFT substrate 202 is decreased significantly.

In order to solve the above problem, as shown in FIG. 6, if the conductive material 104 is configured under side of the BM 102 in complete superposition, then as shown in FIG. 7 and FIG. 8, the thickness of the conductive material 104 of the region D8 will become uniform, because the conductive balls 501 are pressed in the same manner. Thereby no problem of the electrical conductivity exists between the CF substrate 201 and the TFT substrate 202.

Herein, FIG. 6 is a part plan view illustrating that the conductive material 104 is configured under side of the BM 102 in complete superposition.

In FIG. 6, 103 is a cutoff line of the substrate, 603 is a shift cutoff line formed after the cutoff line being moved slightly, 101 is a seal material, and 102 is a BM.

Furthermore, FIG. 7 is a cross sectional view taken along the cutoff line C-C in FIG. 6.

FIG. 8 is an enlarged cross sectional view of portion 401 in FIG. 7.

In FIG. 8, D8 is a region where the conductive material 104 is configured under side of the BM 102 in complete superposition.

However, if the conductive material 104 is configured under side of the BM 102 in complete superposition, then the cut-off line 103 will be close to the BM 102, the BM 102 may be cut off when the cutting is performed, even though the cut-off line 103 is shifted slightly. Under a condition that the BM 102 is cut off partly, the quality problem will not occur, however, if a region with long span of the BM 102 is cut, then sometimes the quality will be impaired, so that this is a major reason for the low yield rate during the manufacture process.

Above-mentioned prior art can refer to Patent Document: Japanese Publication No. 2002-365661.

### SUMMARY OF THE INVENTION

Herein, the object of the invention is to provide a liquid crystal panel having a structure in order to utilize effectively the peripheral portion of the liquid crystal panel. The structure features the conductive material and BM overlap completely. This ensures the conductivity between the TFT substrate and CF substrate by utilizing the conductive material, meanwhile lessens the reduction of the yield rate which is caused by BM being cut off when the cutoff line shifts slightly during cutting the substrate, can be decreased.

The liquid crystal panel at the first aspect of the invention is formed by sandwiching the liquid crystal between a TFT substrate configured with the pixels comprising the thin film transistors in a matrix shape and a CF substrate configured with the color filter (Hereinafter referred to as “CF substrate”), and sealing the peripheral area with the seal material, wherein:

Said seal material and the BM of said CF substrate are configured to overlap completely;

In order to electrically connect said TFT substrate and said CF substrate, the conductive material is adjoined at the outer side of said seal material, and the conductive material and the BM are configured to overlap completely,

And said BM only projects outwardly at the portion where said conductive material is disposed.

Wherein said conductive material comprises electric isolation component with the electric transfer film disposed on the surface of the isolation component.

Wherein said conductive material is in a column shape.

The manufacture method of a liquid crystal panel at the second aspect of the invention comprises: sandwiching the liquid crystal between a TFT substrate comprising the thin film transistors configured in a matrix shape and a CF substrate configured with a color filter, and sealing the peripheral area with the seal material, wherein:

In the process for forming the respective liquid crystal panels from a mother glass substrate used for being cut off for a plurality of liquid crystal panels, it comprises the processes of:

A process for configuring said seal material used for sealing the peripheral area of the respective liquid crystal panels and BM of said CF substrate in complete superposition;

a process for adjoining the conductive material at the outer side of said seal material and configuring the conductive material and the BM in complete superposition in order to electrically connect said TFT substrate and said CF substrate, and

A process for configuring said BM only to project outwardly at the portion where said conductive material is disposed, and to separate the residual portion from the cut off line, which is used for cutting the respective liquid crystal panels from the mother glass substrate, for a certain distance.

Wherein said conductive material comprises electric isolation component with the electric transfer film disposed on the surface of the isolation component.

Wherein said conductive material is in a column shape.

According to the invention, in order to utilize effectively the peripheral portion of the liquid crystal panel, the conductive material and BM overlap completely so that the conductivity between the TFT substrate and CF substrate is ensured by the conductive material, meanwhile the problem in the prior art, i.e. the BM may be cut off during cutting the substrate when the cut off line shifts slightly, which is caused by the superposing completely of the conductive material and BM, will not be occurred, and the yield rate may be prevented from reducing.

### BRIEF DESCRIPTION OF THE DRAWINGS

FIG. 1 is a part plan view illustrating the configuration relationship among BM of a CF substrate at the peripheral area of TFT-LCD panel, a seal material, and a conductive material in the prior art.

FIG. 2 is a cross sectional views taken along the cut off line A-A in FIG. 1.

FIG. 3 is a part plan view in a condition that the seal material 101 and the conductive material 104 are not disposed at the outer side of the BM 102 of the CF substrate, but disposed under side of the BM 102 in complete superposition.

FIG. 4 is a cross sectional view taken along the cut off line B-B in FIG. 3.

FIG. 5 is an enlarged cross sectional view of the portion 401 in FIG. 4.

FIG. 6 is a part plan view illustrating that the conductive material 104 is configured under side of the BM 102 in complete superposition.

FIG. 7 is a cross sectional view taken along the cut off line C-C in FIG. 6.

FIG. 8 is an enlarged cross sectional view of the portion 401 in FIG. 7.

FIG. 9 is a part plan view illustrating the outline of the liquid crystal panel of an embodiment the invention.

FIG. 10 is a cross sectional view taken along the cut off line D-D in FIG. 9.

FIG. 11 is an enlarged cross sectional view of the portion 401 in FIG. 10.

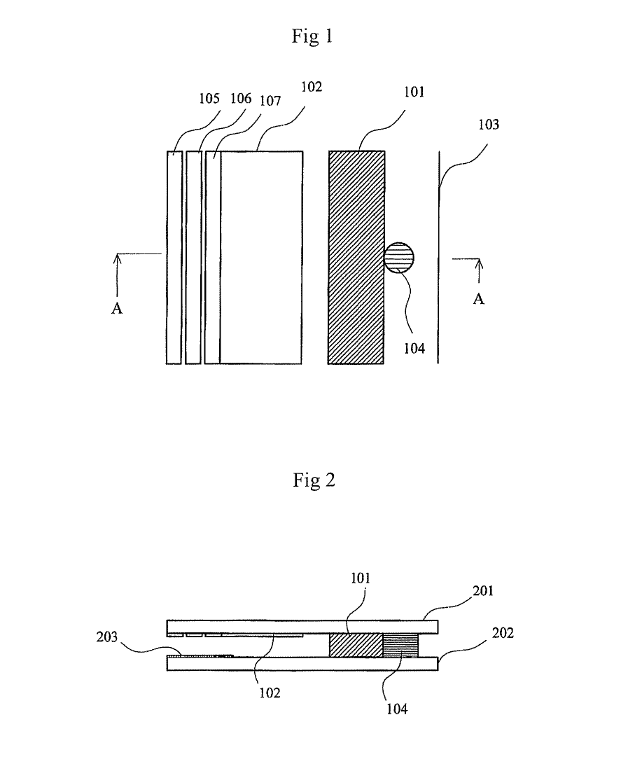

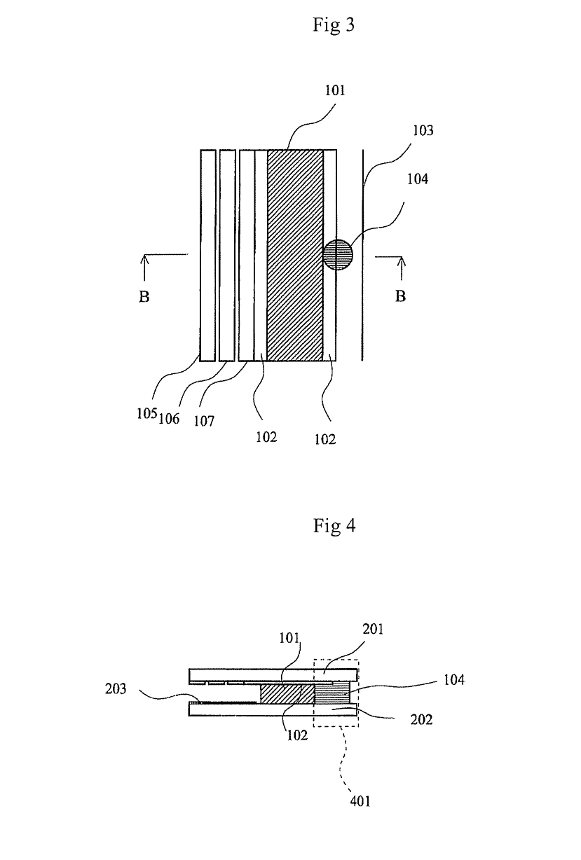

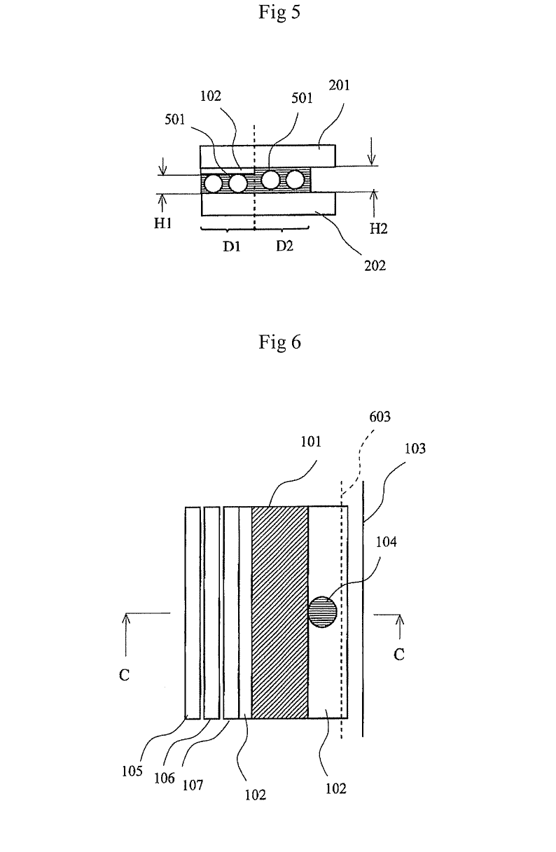

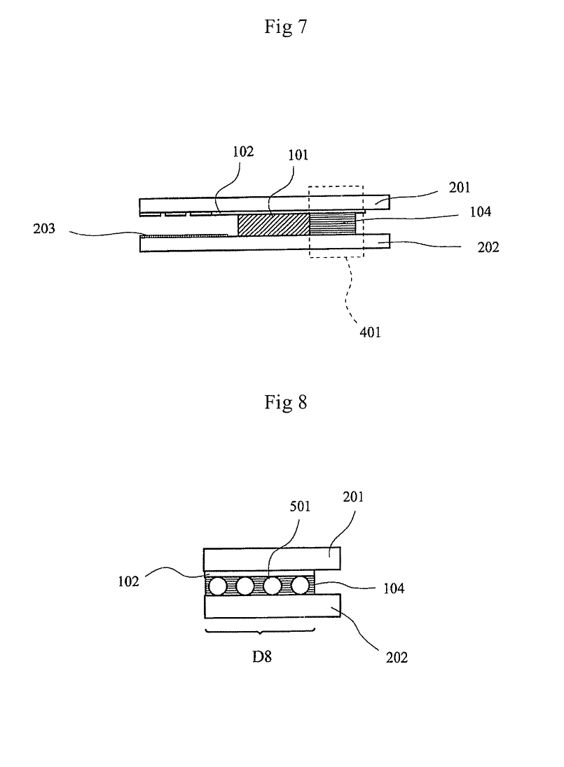

### EXPLANATION OF THE SYMBOLS

101: seal material
102: BM
103: cutoff line
104: conductive material
105: pigmentation of CF substrate
106: pigmentation of CF substrate
107: pigmentation of CF substrate
201: CF substrate, i.e. color filter substrate
202: TFT substrate, i.e. thin film transistor substrate
510: electric ball
603: shift cut off line

### DETAILED DESCRIPTION OF PREFERRED EMBODIMENTS

The embodiments of the invention will be described by referring to the figures as follows.

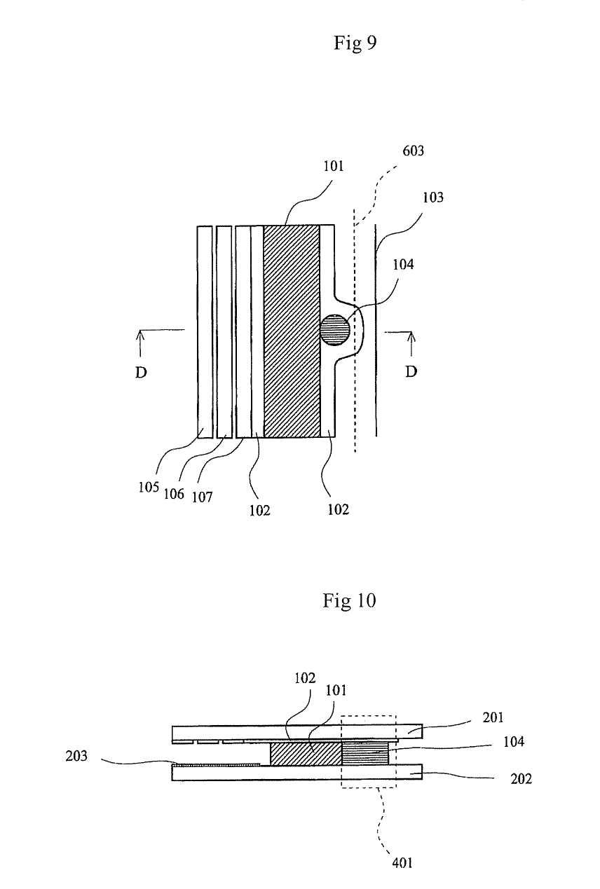

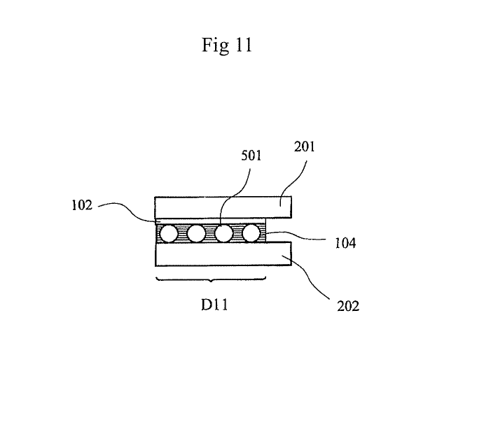

FIG. 9 is a part plan view illustrating the outline of the liquid crystal panel of an embodiment of the invention. In FIG. 9, 102 is BM, 104 is a conductive material, and 101 is a seal material. FIG. 10 is a cross sectional view taken along the cut off line D-D in FIG. 9.

In addition, FIG. 11 is an enlarged cross sectional view of the portion 401 in FIG. 10.

In FIG. 11, D11 is a region where the conductive material 104 is configured under side of the BM 102 in completely superposition.

In the liquid crystal panel of an embodiment of the invention, the conductive material 104 and the BM 102 overlap completely. Therefore, the thickness of the conductive material 104 positioned between the TFf substrate and the CF substrate is uniform, it can be known from FIG. 11, if the conductive balls 501 are sandwiched between the TFT substrate and the CF substrate to be pressed, then they are pressed in the same manner thereby the TFT substrate is connected electrically with the CF substrate. Therefore, the electric conductivity between the TFT substrate and the CF substrate will not be damaged.

Furthermore, as shown in FIG. 9, in a region where the conductive material 104 is disposed, BM 102 extends outwardly surround the conductive material 104, while in other regions, it is disposed as far as possible to separate from the cut off line 103 for a certain distance.

As a result, when the liquid crystal panels are cut off from the mother glass, even under a condition that the cut-off line shifts slightly from 103 to the shifted cut-off line 603, only a portion of BM 102 extending outwardly surround the conductive material 104 is cut off. Under such condition, only a part of BM 102 is cut off, therefore it is not easy to bring the functional problem or the quality problem. Therefore, by using the liquid crystal panel of an embodiment in the invention, the yield rate of the manufacture process can be maintained, the cost can be reduced, and the peripheral region of the liquid crystal panel can be utilized effectively, thereby the requirement of narrowing the frame required in the display device can be satisfied.

Furthermore, the conductive material 104 comprises the electric transfer isolation component with the electric transfer film disposed on the surface of the isolation component, and it can be in a column shape.

Furthermore, the conductive material, the sealing material, the BM and the mother glass are well known, therefore the materials, manufacture method thereof will be omitted.

What is claimed is:

1. A liquid crystal panel, formed by sandwiching the liquid crystal between a thin film transistor substrate configured with the pixels comprising the thin film transistors in a matrix shape and a color filter substrate configured with color filter, and sealing the peripheral area with the seal material, wherein:
Said seal material and a black matrix of said color filter substrate are configured to overlap completely,
In order to electrically connect said thin film transistor substrate and said color filter substrate, a conductive material is adjoined at the outer side of said seal material, and the conductive material and the black matrix are configured to overlap completely,
Said black matrix only projects outwardly at the portion where said conductive material is disposed.

2. The liquid crystal panel of claim 1, wherein:
Said conductive material comprises electric transfer isolation component with the electric transfer film disposed on the surface of the isolation component.

3. The liquid crystal panel as claimed in claim 2, wherein:
Said conductive material is in a column shape.

4. A manufacture method of a liquid crystal panel comprising: sandwiching the liquid crystal between a thin film transistor substrate configured with the pixels comprising the thin film transistors in a matrix shape and a color filter substrate configured with the color filter, and sealing the peripheral area with the seal material, wherein:
In the process for forming the respective liquid crystal panels from a mother glass substrate used for being cut off for a plurality of liquid crystal panels, it comprises the processes of:
a process for configuring said seal material used for sealing the peripheral area of the respective liquid crystal panels and a black matrix of said color filter substrate to overlap completely;
a process for adjoining a conductive material at the outer side of said seal material, and for configuring the conductive material and the black matrix overlap completely in order to electrically connect said thin film transistor substrate to said color filter substrate; and
A process for configuring said black matrix only to project outwardly at the portion where said conductive material is disposed, and to separate the residual portion from the cut-off line, which is used for cutting the respective liquid crystal panels from the mother glass substrate, for a certain distance.

5. The method for manufacturing the liquid crystal panel as claimed in claim 4, wherein:
Said conductive material comprises electric transfer isolation component with the electric transfer film disposed on the surface of the isolation component.

6. The method for manufacturing the liquid crystal panel as claimed in claim 5, wherein:
Said conductive material is in a column shape.
